(19) United States
(12) Patent Application Publication
(10) Pub. No.: US 2019/0281671 A1
(43) Pub. Date: Sep. 12, 2019

(54) LIGHTING DEVICE USING AMBIPOLAR TRANSISTORS

(71) Applicant: Teresa OH, Cheongju-si (KR)

(72) Inventor: Teresa OH, Cheongju-si (KR)

(21) Appl. No.: 15/913,036

(22) Filed: Mar. 6, 2018

(51) Int. Cl. H05B 33/08; H05B 37/02; H05B 33/06

(52) U.S. Cl. CPC H05B 33/0803; H05B 33/06; H05B 37/02

(57) ABSTRACT

Disclosed are a light device using an ambipolar transistor, which comprises an LED connected to a drain electrode; a power source connected to the LED; a source electrode connected to the power source; and a gate electrode connected to both the LED and the drain electrode, wherein diffusion current between the source electrode and the drain electrode allows reception of electronic signal. The ambipolar transistor includes: a substrate; a gate formed on the substrate; a gate insulating film formed of an SiOC thin film and disposed on the substrate and the gate; and a source portion and a drain portion formed on the gate insulating film and spaced apart from each other, wherein the source portion and the drain portion comprise: a main source terminal and a main drain terminal disposed on the gate insulating film at right and left sides of the gate, respectively; and a plurality of source sub-terminals and a plurality of drain sub-terminals alternately arranged between the main source terminal and the main drain terminal, respectively.

### TECHNICAL FIELD

The present invention relates to a lighting device using ambipolar transistors and, and more particularly, to a lighting device using LED which creates heat caused by accompanied resistors but was cancelled its heat via an ambipolar transistor, which can prevent current leakage using diffusion current having negative resistance characteristics due to a potential barrier caused by dielectrics, and can block leakage current in a lighting device.

### BACKGROUND

Recently, an electric vehicle market has been gradually expanded. The life of a battery is closely related to the charging method and the discharging phenomenon and thus can be prolonged by removing leakage current.

In an electric vehicle composed of various electronic devices, a leakage current cut-off sensor is an essential component. However, there can actually be problems such as short circuit or over-discharge of a battery, overheating of an LED lamp, generation of sparks, and reduction in lifespan of electronic devices due to electrical instability. These problems can be caused by various factors, but are mainly caused by noise and leakage current.

Conventionally, in order to protect an electronic device by blocking leakage current, a circuit breaker or a constant voltage controller configured to cut off leakage current using a Zener diode when voltage falls below a predetermined voltage is used. However, the above problems can be naturally solved if current leakage can be prevented.

That is, it is possible to avoid overheating, spark generation, and the like by fundamentally preventing current leakage.

In addition, reduction in size of semiconductor devices provides a problem relating to SiO₂ thin film dielectrics, such as increase in power consumption due to current leakage, signal interference, and the like, due to limitations of silicon semiconductor technology. Moreover, current leakage provides serious problems in applications including various electronic sensors using semiconductors, displays, smart phones, and batteries.

Further, LEDs (light emitting diodes) are widely used as light source or back light unit in most electronic device from a large scale display to mobile display.

However, the LEDs create much heat caused by accompanied resistors, for this reason lighting devices with LEDs need to be equipped with heat sinks. Also, the LEDs in lighting devices are supplied with only DC to work, and inverter and/or converter are indispensable to lighting devices if AC is supplied to the LEDs.

### BRIEF SUMMARY

In accordance with one embodiment of the present invention, a light device using an ambipolar transistor, comprising: an LED connected to a drain electrode; a power source connected to the LED; a source electrode connected to the power source; and a gate electrode connected to both the LED and the drain electrode, wherein diffusion current between the source electrode and the drain electrode allows reception of electronic signal, and the ambipolar transistor comprises: a substrate; a gate formed on the substrate; a gate insulating film formed of an SiOC thin film and disposed on the substrate and the gate; and a source portion and a drain portion formed on the gate insulating film and spaced apart from each other, wherein the source portion and the drain portion comprise: a main source terminal and a main drain terminal disposed on the gate insulating film at right and left sides of the gate, respectively; and a plurality of source sub-terminals and a plurality of drain sub-terminals arranged between the main source terminal and the main drain terminal, respectively.

In accordance with a further embodiment of the present invention, a light device using an ambipolar transistor, comprising: an LED connected to a drain electrode; a power source connected to the LED; a source electrode connected to the power source; and a gate electrode connected to both the source electrode and the power source, wherein diffusion current between the source electrode and the drain electrode allows reception of electronic signal, and the ambipolar transistor comprises: a substrate; a gate formed on the substrate; a gate insulating film formed of an SiOC thin film and disposed on the substrate and the gate; and a source portion and a drain portion formed on the gate insulating film and spaced apart from each other, wherein the source portion and the drain portion comprise: a main source terminal and a main drain terminal disposed on the gate insulating film at right and left sides of the gate, respectively; and a plurality of source sub-terminals and a plurality of drain sub-terminals arranged between the main source terminal and the main drain terminal, respectively

In accordance with a further embodiment of the present invention, a light device using an ambipolar transistor, comprising: an LED connected to a drain electrode; a power source connected to the LED; a source electrode connected to the power source; and a gate electrode connected to the LED, the drain electrode, the source electrode and the power source, wherein diffusion current between the source electrode and the drain electrode allows reception of electronic signal, and the ambipolar transistor comprises: a substrate; a gate formed on the substrate; a gate insulating film formed of an SiOC thin film and disposed on the substrate and the gate; and a source portion and a drain portion formed on the gate insulating film and spaced apart from each other, wherein the source portion and the drain portion comprise: a main source terminal and a main drain terminal disposed on the gate insulating film at right and left sides of the gate, respectively; and a plurality of source sub-terminals and a plurality of drain sub-terminals arranged between the main source terminal and the main drain terminal, respectively.

The resistor is connected between the gate and the LED.

The resistor is connected between the gate and the source electrode.

The resistor is connected between the gate and the LED, while a resistor is connected between the gate and the source electrode.

The resistor is connected between the gate and the LED, while a resistor is connected between the gate and the source electrode.

Another ambipolar transistor is connected between the gate of one ambipolar transistor and the LED such that the gate electrode of another ambipolar transistor is connected to the drain electrode of another ambipolar transistor, the drain electrode of one ambipolar transistor and the LED.

Another ambipolar transistor is connected between the gate and the source electrode of one ambipolar transistor and between the gate of one ambipolar transistor and the power source such that the gate electrode of another ambipolar transistor is connected to the source electrode of another ambipolar transistor, the source electrode of one ambipolar transistor and the power source.

Another ambipolar transistor is connected between the gate of one ambipolar transistor and the LED such that the gate electrode of another ambipolar transistor is connected to the drain electrode of another ambipolar transistor, the drain electrode of one ambipolar transistor and the LED, and wherein the other ambipolar transistor is connected between the gate and the source electrode of one ambipolar transistor and between the gate of one ambipolar transistor and the power source such that the gate electrode of the other ambipolar transistor is connected to the source electrode of the other ambipolar transistor, the source electrode of one ambipolar transistor and the power source.

The gate electrode of another ambipolar transistor is connected to the gate electrode of the other ambipolar transistor.

The resistor is connected between the gate electrode of the one ambipolar transistor and the source electrode of another ambipolar transistor, and a resistor is connected between the gate electrode and the drain electrode of another ambipolar transistor.

The resistor is connected between the gate electrode of the one ambipolar transistor and the drain electrode of another ambipolar transistor, and a resistor is connected between the gate electrode and the source electrode of another ambipolar transistor.

The resistor is connected between the gate electrode of the one ambipolar transistor and the source electrode of the another ambipolar transistor and the drain electrode of the other ambipolar transistor, and a resistor is connected between the gate electrode and the source electrode of another ambipolar transistor, and, wherein a resistor is connected between the gate electrode of one ambipolar transistor and the drain electrode of the other ambipolar transistor, and a resistor is connected between the gate electrode and the source electrode of the other ambipolar transistor.

The power source is an AC power source.

### BRIEF DESCRIPTION OF THE DRAWINGS

The above and other aspects, features and advantages of the present invention will become apparent from the following description of embodiments given in conjunction with the accompanying drawings, in which:

FIG. 1 is a top view of a series pattern diffusion current transistor according to the present invention;

FIG. 2 is a view of a source-drain terminal pattern of the series pattern diffusion current transistor of FIG. 1;

FIG. 3 is a sectional view of the series pattern diffusion current transistor of FIG. 1;

FIG. 4 is a sectional view of a series pattern diffusion current transistor according to one embodiment of the present invention;

FIG. 5 is a sectional view of a series pattern diffusion current transistor according to a further of the present invention;

FIG. 6 is a sectional view of a series pattern diffusion current transistor according to a further embodiment of the present invention;

FIG. 7 is a sectional view of a series pattern diffusion current transistor according to a further embodiment of the present invention;

FIG. 8 is a graph depicting transfer characteristics of an ambipolar transistor using a single layer of a gate insulating film;

FIG. 9 is a graph depicting transfer characteristics of the series pattern diffusion current transistor according to the present invention; and

FIG. 10 is a graph depicting the transfer characteristics of the series pattern diffusion current transistor of FIG. 8 on a log scale.

FIG. 11 is a circuit diagram of a lighting device using the ambipolar transistor according to the embodiments of the present invention;

FIG. 12 is a circuit diagram of a lighting device using the ambipolar transistor according to the embodiments of the present invention;

FIG. 13 is a circuit diagram of a lighting device using the ambipolar transistor combined with two circuits in FIG. 11 and FIG. 12;

FIG. 14 is a circuit diagram in which a resistor is connected to the gate of FIG. 11;

FIG. 15 is a circuit diagram in which a resistor is connected to the gate of FIG. 12;

FIG. 16 is a circuit diagram of a lighting device using the ambipolar transistor combined with two circuits in FIG. 14 and FIG. 15;

FIG. 17 is a circuit diagram in which a ambipolar transistor resistor is connected to the gate of FIG. 11;

FIG. 18 is a circuit diagram in which a ambipolar transistor resistor is connected to the gate of FIG. 12;

FIG. 19 is a circuit diagram of a lighting device using the ambipolar transistor combined with two circuits in FIG. 17 and FIG. 18;

FIG. 20 is a circuit diagram in which a resistor is connected to the gate of FIG. 17;

FIG. 21 is a circuit diagram in which a resistor is connected to the gate of FIG. 18; and

FIG. 22 is a circuit diagram of a lighting device using the ambipolar transistor combined with two circuits in FIG. 20 and FIG. 21.

### DETAILED DESCRIPTION

Hereinafter, embodiments of the present invention will be described in detail with reference to the accompanying drawings.

The present invention relates to an ambipolar transistor which can generate diffusion current using a negative resistance caused by a potential barrier (negative potential) of a thin insulating film without using a channel layer in order to solve problems caused by current leakage, and a leakage current cutoff device using the same.

A typical transistor has a structure in which a source terminal is separated from a drain terminal by a gate and a gate insulating film and a channel is formed between the source and drain terminals. In addition, change of a current value is mainly controllable by the channel. Thus, in such a transistor, the source terminal and the drain terminal cannot be arranged to have series or parallel connection.

In a transistor without a channel layer, diffusion current is generated by spontaneous polarization caused by a potential difference due to a potential barrier created by a depletion layer or an amorphous insulating film. Dielectrics exhibit spontaneous polarization. Thus, due to transfer characteristics of diffusion current, when a negative (−) voltage is applied to an SiOC insulating film as a gate insulating film, a positive (+) diffusion current flows on the opposite side, and when a positive (+) voltage is applied to the SiOC insulating film, a negative (−) diffusion current flows on the opposite side. Thus, when the SiOC thin film is used as the gate insulating film, it is possible to obtain a transistor capable of exhibiting ambipolar transfer characteristics depending upon the position of the gate.

Such a diffusion current generated due to spontaneous polarization of the dielectrics acts in a direction opposite the direction of a drift current and thus can reduce the internal potential difference. Thus, when the SiOC insulating film is disposed at a metal/semiconductor interface, which can cause increase in resistance due to metal contact, due to spontaneous polarization of dielectrics having a low dielectric constant, a potential barrier caused by the insulating film generates a diffusion current acting in a direction opposite the direction of a drift current, thereby allowing much current to flow through the metal contact by preventing increase in resistance due to metal contact.

Therefore, such a transistor having ambipolar transfer characteristics without current leakage can minimize contact resistance at the interface to allow more diffusion current to flow, thereby increasing efficiency of an electronic device.

Hereinafter, embodiments of a transistor capable of generating diffusion current using a SiOC gate insulating film and a leakage current cutoff device using the same will be described in detail with reference to the accompanying drawings.

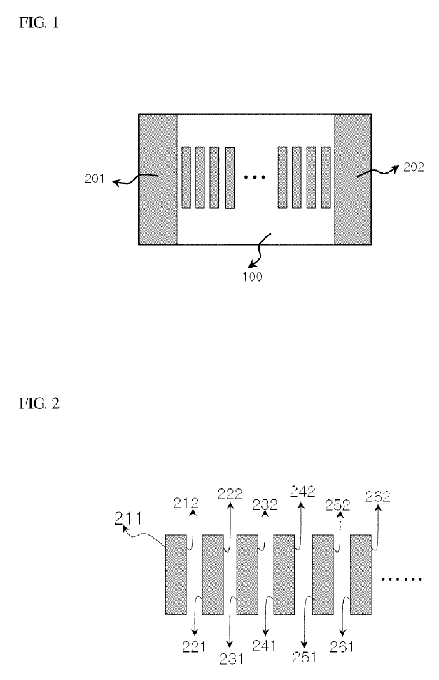

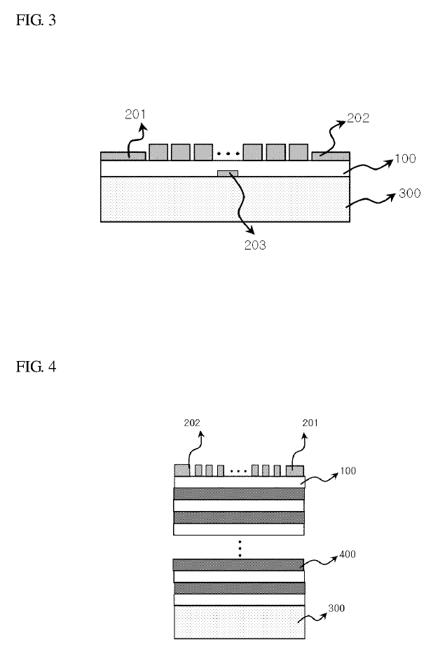

FIG. 1 is a top view of a series pattern diffusion current transistor according to a first embodiment of the present invention, FIG. 2 is a view of a source-drain terminal pattern of the series pattern diffusion current transistor of FIG. 1, and FIG. 3 is a sectional view of the series pattern diffusion current transistor of FIG. 1.

Referring to FIGS. 1 to 3, an ambipolar transistor using diffusion current according to a first embodiment of the present invention includes: a gate 203 formed on a substrate 300; a gate insulating film 100 formed on the substrate 300 and the gate 203 and formed of a SiOC thin film; and a source portion and a drain portion formed on the gate insulating layer 100 and spaced apart from each other.

In addition, when drain and source signal lines are disposed on the gate insulating film 100, in order to amplify electrical signals (voltage) while increasing sensitivity, the source portion and the drain portion may include: a main source terminal 202 and a main drain terminal 201; and a plurality of source sub-terminals and a plurality of drain sub-terminals, respectively, wherein the plurality of source sub-terminals 212, 222, 232, . . . and the plurality of drain sub-terminals 211, 221, 231, . . . are each formed of a metal wire and are alternately arranged to be connected to each other in series.

The transistor according to the present invention has a structure in which the main source terminal 202 and the main drain terminal 201 are stacked on the gate insulating film 100 without a channel layer, unlike a typical transistor having a channel layer. Here, the gate insulating film 100 is formed of a SiOC thin film and preferably has a dielectric constant of 1.0 to 2.5.

Further, in order for an electronic sensor fabricated using the transistor to have high sensitivity, the gate insulating film 100 has a leakage current of 10⁻¹⁴ A to 10⁻¹⁰ A and is required to be amorphous instead of exhibiting polarization.

The SiOC thin film used as the gate insulating film of the transistor according to the present invention may be formed by a process in which an SiOC target is deposited by sputtering, ICP-CVD, or PE-CVD, followed by heat treatment.

In order to reduce polarization of the SiOC film, that is, to inhibit increase in polarization due to carbon and oxygen, the carbon content is controlled. When the carbon content of the SiOC target is 0.1% or less, it is difficult to form the SiOC thin film. Preferably, the carbon content of the SiOC target ranges from 0.05% to 15% so as to restrict the dielectric constant of the gate insulating film 100 to a range of 1.0 to 2.5.

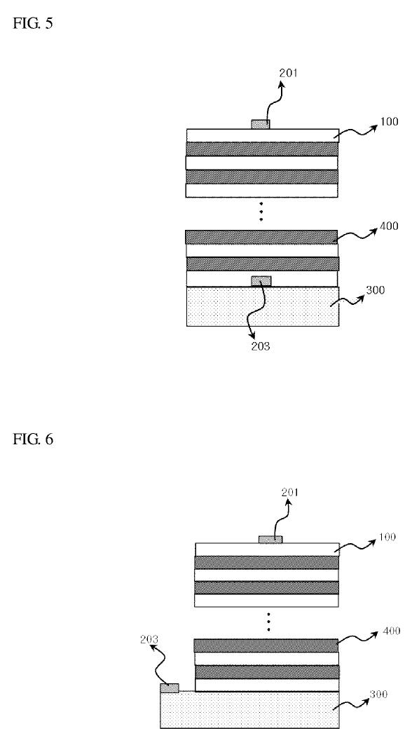

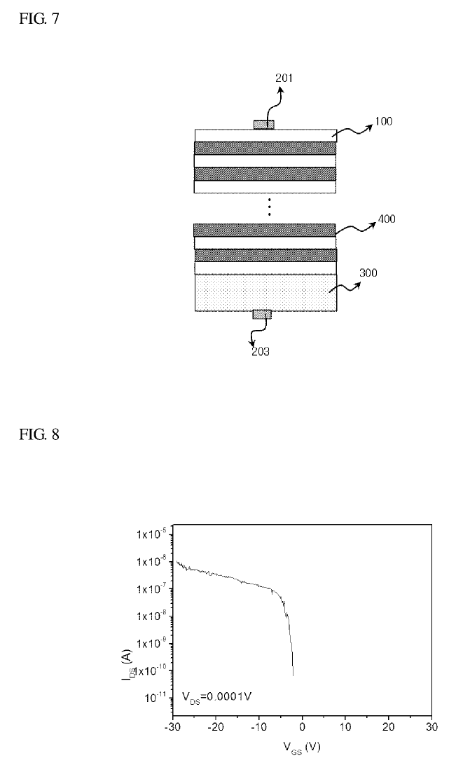

FIG. 4 is a sectional view of a series pattern diffusion current transistor according to a second embodiment of the present invention, FIG. 5 is a sectional view of a series pattern diffusion current transistor according to a third embodiment of the present invention, FIG. 6 is a sectional view of a series pattern diffusion current transistor according to a fourth embodiment of the present invention, and FIG. 7 is a sectional view of a series pattern diffusion current transistor according to a fifth embodiment of the present invention.

An ambipolar transistor using diffusion current according to a second embodiment of the present invention includes a gate 203 connected to a substrate 300, an interlayer electrode 400 formed on the substrate, an SiOC insulating film 100 formed on the interlayer electrode 400, and a source portion and a drain portion formed on the interlayer electrode and spaced apart from each other, wherein the interlayer electrode and the SiOC insulating film 100 include a plurality of interlayer electrodes and a plurality of SiOC insulating films alternately stacked one above another, respectively.

In addition, the source portion and the drain portion include: a main source terminal 202 and a main drain terminal 201 disposed at right and left sides of the SiOC insulating film 100, respectively; and a plurality of source sub-terminals and a plurality of drain sub-terminals, respectively, wherein the plurality of source sub-terminals 212, 222, 232, . . . and the plurality of drain sub-terminals 211, 221, 231, . . . are each formed of a metal wire and are alternately arranged to be connected to each other in series.

As in the first embodiment, the SiOC thin film 100 preferably has a dielectric constant of 1.0 to 2.5 and a leakage current of 10⁻¹⁴ A to 10⁻¹⁰ A, and is required to be amorphous instead of exhibiting polarization.

FIG. 5 is a sectional view of a series pattern diffusion current transistor according to a third embodiment of the present invention. In this embodiment, the gate is formed in the SiOC insulating film 100 on the substrate.

FIG. 6 is a sectional view of a series pattern diffusion current transistor according to a fourth embodiment of the present invention. In this embodiment, the gate is formed at an edge of the substrate outside the SiOC insulating film.

FIG. 7 is a sectional view of a series pattern diffusion current transistor according to a fifth embodiment of the present invention. In this embodiment, the gate is formed under the substrate.

In the ambipolar diffusion current transistors according to the second to fifth embodiments, the interlayer electrode 400 may be form of any one selected from aluminum (Al), nanowire, graphene, ITO, transparent conductive oxide (TCO), AZO, ZTO, IGZO, ZITO, SiZO, hybrid (composite), and CNT-based transparent electrodes.

In the ambipolar diffusion current transistors according to the second to fifth embodiments, the interlayer electrode 400 is stacked on the substrate 300, the SiOC insulating film 100 is stacked on the interlayer electrode, and the plurality of source terminals and the plurality of drain terminals are alternately arranged to be connected to each other in series between the main drain terminal 201 and the main source terminal 202.

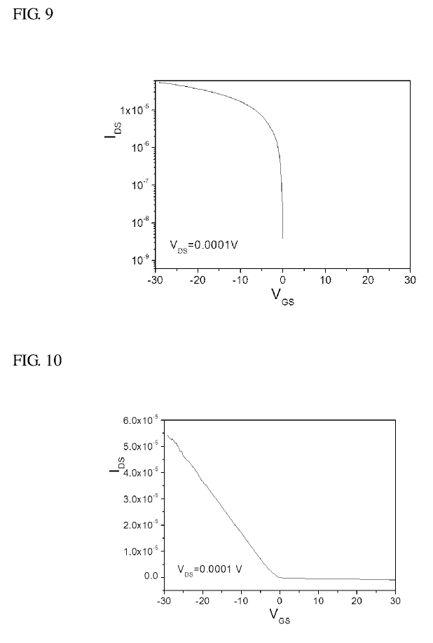

FIG. 8 is a graph depicting transfer characteristics of an ambipolar transistor using a single layer of a gate insulating film; FIG. 9 is a graph depicting transfer characteristics of the series pattern diffusion current transistor according to the present invention; and FIG. 10 is a graph depicting the transfer characteristics of the series pattern diffusion current transistor of FIG. 8 on a log scale.

As shown in FIG. 8, it can be seen that a very low current of about −10⁻⁶ A flows through the ambipolar transistor using the single layer of the gate insulating film. Conversely, as shown in FIG. 12, it can be seen that the current value is increased to −10⁻⁴ A due to the influence of a series pattern in the series pattern diffusion current transistor.

In addition, linear characteristics of I_{DS}-V_{GS} transfer characteristics of the series connection-type transistor according to the first embodiment exhibit ambipolarity. That is, when a gate voltage is redirected from the negative direction to the positive direction, a drain current is redirected from the positive direction to the negative direction. Since the gate insulating film 100 can induce tunneling of a diffusion current due to spontaneous polarization of an amorphous dielectric, when a negative bias is applied to the gate 203, a (+) source-drain current flows through the thin film transistor, whereas when a positive bias is applied to the gate, a (−) source-drain current flows through the transistor.

FIG. 10 is a graph depicting mobility and on/off characteristics acquired by converting the IDS-VGS transfer characteristics of FIG. 8 into a log scale. As shown in FIG. 10, it can be seen that the stability and mobility of the transfer characteristics increase with decreasing drain voltage.

Referring to FIG. 10, as the drain voltage decreases, tunneling of minority carriers at an interface between a semiconductor and the gate insulating film can be more easily achieved. Preferably, a bias applied to the drain ranges from 10⁻⁴ V to 1 V.

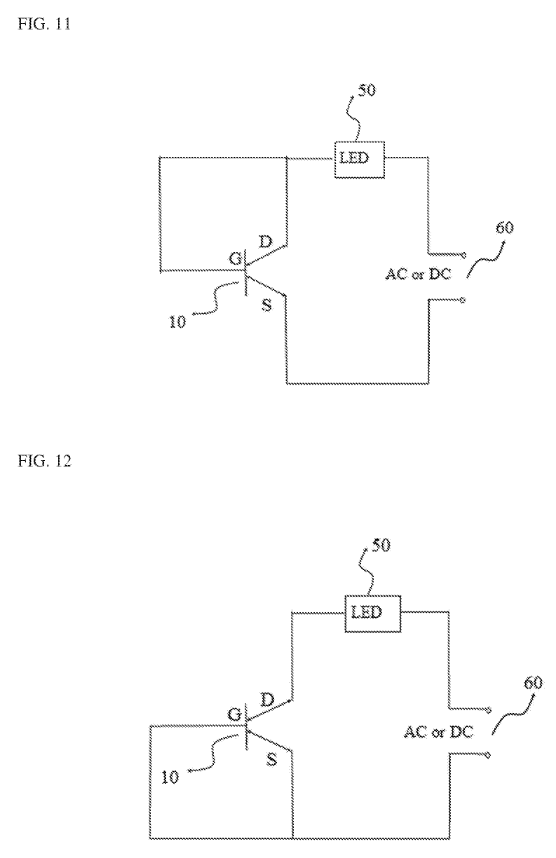

FIG. 11 is a circuit diagram of a lighting device using the ambipolar transistor according to the embodiments of the present invention.

Referring to FIG. 11, the lighting device using the ambipolar transistor includes: an LED 50 connected to a drain electrode D; a power source 60 connected to the LED 50; a source electrode S connected to the power source 60; and a gate electrode G connected to both the LED 50 and the drain electrode D, wherein diffusion current between the source electrode S and the drain electrode D allows reception of electronic signal, Here, the ambipolar transistor 10 including the gate, the drain terminal, and the source terminal may be any one of the ambipolar transistors, which comprises a substrate; a gate formed on the substrate; a gate insulating film formed of an SiOC thin film and disposed on the substrate and the gate; and a source portion and a drain portion formed on the gate insulating film and spaced apart from each other, wherein the source portion and the drain portion comprise: a main source terminal and a main drain terminal disposed on the gate insulating film at right and left sides of the gate, respectively; and a plurality of source sub-terminals and a plurality of drain sub-terminals arranged between the main source terminal and the main drain terminal respectively, as shown in FIGS. 1 to 7.

An lighting device using the ambipolar transistor according to the first embodiment as shown in FIG. 1 includes: a gate 203 formed on a substrate 300; a gate insulating film 100 formed on the substrate 300 and the gate and formed of a SiOC thin film; and a source portion and a drain portion formed on the gate insulating film 100 and spaced apart from each other.

When drain and source signal lines are disposed on the gate insulating film 100, in order to amplify electrical signals (voltage) while increasing sensitivity, the source portion and the drain portion may include: a main source terminal 202 and a main drain terminal 201; and a plurality of source sub-terminals and a plurality of drain sub-terminals, respectively, wherein the plurality of source sub-terminals 212, 222, 232, . . . and the plurality of drain sub-terminals 211, 221, 231, . . . are alternately arranged to be connected to each other in series.

An lighting device using the ambipolar transistor according to the second embodiment as shown in FIG. 2 includes: a gate 203 connected to a substrate 300; an interlayer electrode 400 formed on the substrate; an SiOC insulating film 100 formed on the interlayer electrode 400; and a source portion and a drain portion formed on the SiOC insulating film and spaced apart from each other, wherein the interlayer electrode and the SiOC insulating film 100 include a plurality of interlayer electrodes and a plurality of SiOC insulating films alternately stacked one above another, respectively.

In addition, the source portion and the drain portion include: a main source terminal 202 and a main drain terminal 201 disposed at right and left sides of the SiOC insulating film 100, respectively; and a plurality of source sub-terminals and a plurality of drain sub-terminals, respectively, wherein the plurality of source sub-terminals 212, 222, 232, . . . and the plurality of drain sub-terminals 211, 221, 231, . . . are each formed of a metal wire and are alternately arranged to be connected to each other in series.

Referring to FIG. 11, the positive(+) voltage of a drain electrode D is supplied to a gate electrode and an depletion effect in SiOC insulating films are increased such that an electric potential barrier can be increased. Because the negative(−) the difference of the electrical potential increases, the electrical potential barrier supplied to LED 50 is high. According to high diffusion current, the luminous intensity of LED increases. As a result, LED is operated by diffusion current with high efficiency and so it doesn't emit heat.

FIG. 12 is a circuit diagram of a lighting device using the ambipolar transistor according to the different embodiment of the present invention, which comprises; an LED 50 connected to a drain electrode D; a power source 60 connected to the LED 50; a source electrode S connected to the power source 60; and a gate electrode G connected to both the source electrode S and the power source 60, wherein diffusion current between the source electrode S and the drain electrode D allows reception of electronic signal. Here, the ambipolar transistor 10 including the gate, the drain terminal, and the source terminal may be any one of the ambipolar transistors as shown in FIGS. 1 to 7.

FIG. 12 is a circuit diagram of a lighting device using the ambipolar transistor according to the embodiments of the present invention, which is the same as the circuit diagram in FIG. 11 except for connection from gate G to source electrode S instead of connection from gate G to drain electrode D.

FIG. 13 is a circuit diagram of a lighting device using the ambipolar transistor combined with two circuits in FIG. 11 and FIG. 12. the circuit diagram in FIG. 13 comprises; an LED 50 connected to a drain electrode D; a power source 60 connected to the LED 50; a source electrode S connected to the power source 60; and a gate electrode G connected to the LED 50, the drain electrode D, the source electrode S and the power source 60, wherein diffusion current between the source electrode and the drain electrode allows reception of electronic signal. Here, the ambipolar transistor 10 including the gate, the drain terminal, and the source terminal may be any one of the ambipolar transistors as shown in FIGS. 1 to 7.

Because a circuit diagram of a lighting device has a problem of flickering when AC power source is supplied to the power source 60, it is preferred to design symmetrically the circuit diagram of a lighting device as shown in FIG. 13.

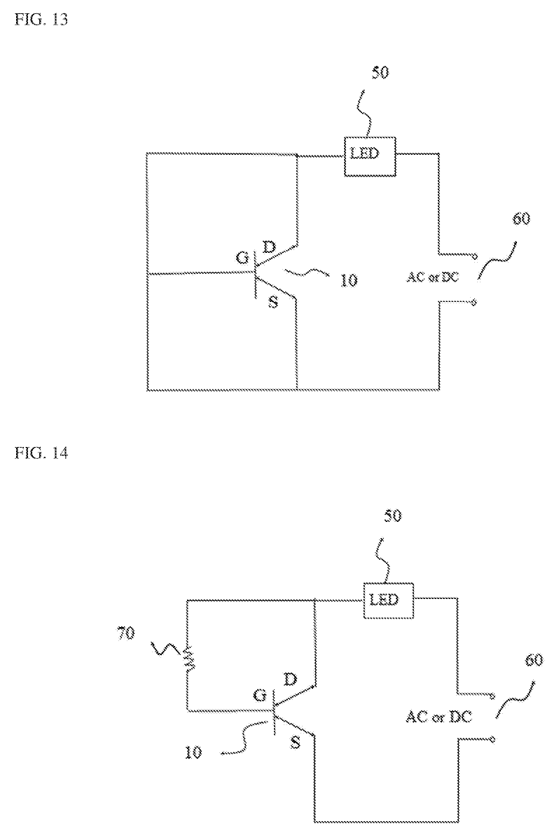

FIG. 14 is a circuit diagram in which a resistor 70 is connected to the gate of FIG. 11. In this embodiment, a diffusion current at the gate is affected by gate voltage and gate resistance, and a signal current is converted into a diffusion current between the source terminal and the drain terminal. The amount of diffusion current flowing between the source terminal and the drain terminal can be controlled by the gate. In this reason, if the circuit is provided with resistor 70 connected to the gate, the negative voltage of the gate is much more decreased, thereby controlling tunneling effect.

FIG. 15 is a circuit diagram in which a resistor 70 is connected to the gate of FIG. 12 in the same reason as in FIG. 14.

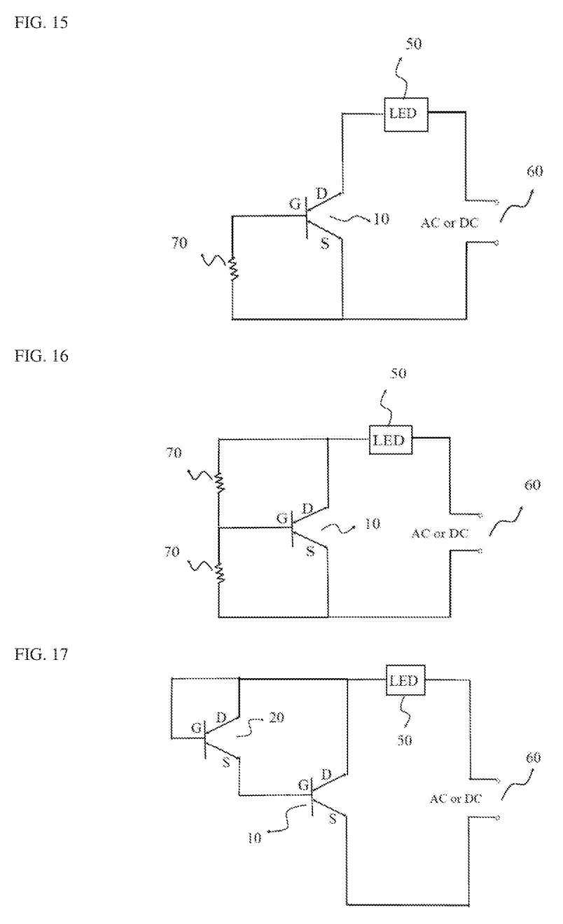

FIG. 16 is a circuit diagram of a lighting device using the ambipolar transistor combined with two circuits in FIG. 14 and FIG. 15, in which wherein a resistor 70 is connected between the gate electrode G and the LED 50, while a resistor 70 is connected between the gate electrode G and the source electrode S.

FIG. 17 is a circuit diagram in which another ambipolar transistor resistor is connected to the gate of FIG. 11. The light device using ambipolar transistors shown in FIG. 17, where another ambipolar transistor 20 is connected between the gate electrode S of one ambipolar transistor 10 and the LED 50 such that the gate electrode G of another ambipolar transistor 20 is connected to the drain electrode D of another ambipolar transistor 20, the drain electrode D of one ambipolar transistor 10 and the LED 50. Here, the ambipolar transistors 10, 20 including the gate, the drain terminal, and the source terminal may be any of the ambipolar transistors as shown in FIGS. 1 to 7.

FIG. 18 is a circuit diagram in which another ambipolar transistor resistor is connected to the gate of FIG. 12. The light device using ambipolar transistors shown in FIG. 18, where another ambipolar transistor 30 is connected between the gate electrode G and the source electrode S of one ambipolar transistor 10 and between the gate electrode G of one ambipolar transistor 10 and the power source 60 such that the gate electrode G of another ambipolar transistor 30 is connected to the source electrode S of another ambipolar transistor 30, the source electrode S of one ambipolar transistor 10 and the power source 60. Here, the ambipolar transistors 10, 30 including the gate, the drain terminal, and the source terminal may be any of the ambipolar transistors as shown in FIGS. 1 to 7.

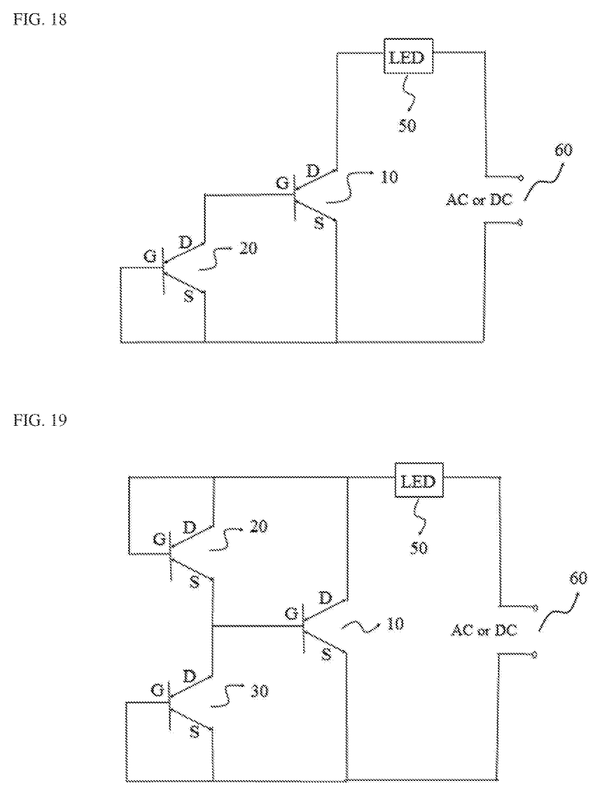

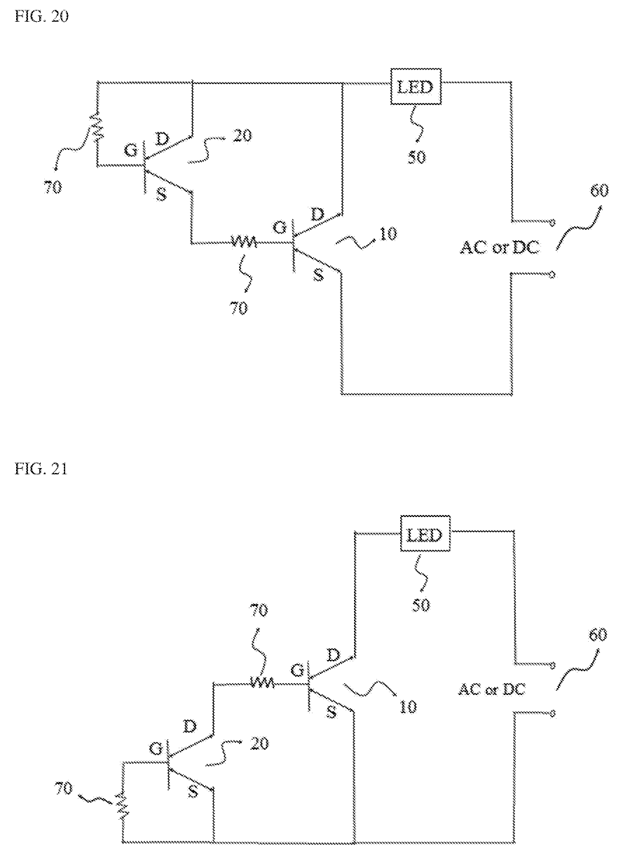

FIG. 19 is a circuit diagram of a lighting device using the ambipolar transistor combined with two circuits in FIG. 17 and FIG. 18, where another ambipolar transistor 20 is connected between the gate electrode G of one ambipolar transistor 10 and the LED 50 such that the gate electrode S of another ambipolar transistor 20 is connected to the drain electrode D of another ambipolar transistor 20, the drain electrode D of one ambipolar transistor 10 and the LED 50, and wherein the other ambipolar transistor 30 is connected between the gate electrode G and the source electrode of one ambipolar transistor and between the gate electrode G of one ambipolar transistor 10 and the power source 60 such that the gate electrode G of the other ambipolar transistor 10 is connected to the source electrode S of the other ambipolar transistor 30, the source electrode S of one ambipolar transistor 10 and the power source 60. And, it is preferred to design symmetrically the circuit diagram of a lighting device as shown in FIG. 19.

FIG. 20 is a circuit diagram in which a resistor is connected to the gate electrode of FIG. 17, wherein a resistor 70 is connected between the gate electrode G of the one ambipolar transistor 10 and the source electrode S of another ambipolar transistor 20, and a resistor 70 is connected between the gate electrode S and the drain electrode D of another ambipolar transistor 20.

FIG. 21 is a circuit diagram in which a resistor is connected to the gate of FIG. 18, wherein a resistor 70 is connected between the gate electrode G of the one ambipolar transistor 10 and the drain electrode D of another ambipolar transistor 20, and a resistor 70 is connected between the gate electrode G and the source electrode S of another ambipolar transistor 20.

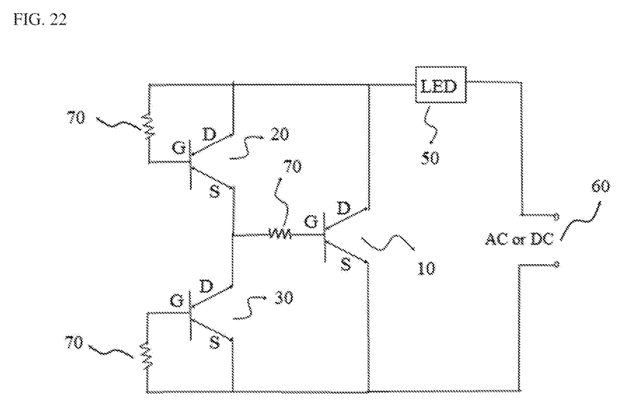

FIG. 22 is a circuit diagram of a lighting device using the ambipolar transistor combined with two circuits in FIG. 20 and FIG. 21, wherein a resistor 70 is connected between the gate electrode G of the one ambipolar transistor 10 and the source electrode S of the another ambipolar transistor 20 and the drain electrode D of the other ambipolar transistor 30, and a resistor 70 is connected between the gate electrode G and the source electrode S of another ambipolar transistor 20, and, wherein a resistor 70 is connected between the gate electrode G of one ambipolar transistor 10 and the drain electrode D of the other ambipolar transistor 30, and a resistor 70 is connected between the gate electrode G and the source electrode S of the other ambipolar transistor 30.

The power source can be applied to not only DC (direct current) but also AC (alternative current). Even though AC power source is supplied to circuits in the above embodiments shown as in FIGS. 10 to 22, it is advantageous not to use inverter or convertor for all circuit using the ambipolar transistors in the present embodiments.

Although some embodiments have been disclosed above, it should be understood that these embodiments are given by way of illustration only, and that various modifications, variations, and alterations can be made without departing from the spirit and scope of the present invention. Therefore, the scope of the present invention should be limited only by the accompanying claims and equivalents thereof.

What is claimed is:

1. A light device using an ambipolar transistor, comprising:
an LED connected to a drain electrode;
a power source connected to the LED;
a source electrode connected to the power source; and
a gate electrode connected to both the LED and the drain electrode,
wherein diffusion current between the source electrode and the drain electrode allows reception of electronic signal, and
the ambipolar transistor comprises:
a substrate;
a gate formed on the substrate;
a gate insulating film formed of an SiOC thin film and disposed on the substrate and the gate; and
a source portion and a drain portion formed on the gate insulating film and spaced apart from each other,
wherein the source portion and the drain portion comprise: a main source terminal and a main drain terminal disposed on the gate insulating film at right and left sides of the gate, respectively; and a plurality of source sub-terminals and a plurality of drain sub-terminals arranged between the main source terminal and the main drain terminal, respectively.

2. A light device using an ambipolar transistor, comprising:
an LED connected to a drain electrode;
a power source connected to the LED;
a source electrode connected to the power source; and
a gate electrode connected to both the source electrode and the power source,
wherein diffusion current between the source electrode and the drain electrode allows reception of electronic signal, and
the ambipolar transistor comprises:
a substrate;
a gate formed on the substrate;
a gate insulating film formed of an SiOC thin film and disposed on the substrate and the gate; and
a source portion and a drain portion formed on the gate insulating film and spaced apart from each other,
wherein the source portion and the drain portion comprise: a main source terminal and a main drain terminal disposed on the gate insulating film at right and left sides of the gate, respectively; and a plurality of source sub-terminals and a plurality of drain sub-terminals arranged between the main source terminal and the main drain terminal, respectively.

3. A light device using an ambipolar transistor, comprising:
an LED connected to a drain electrode;
a power source connected to the LED;
a source electrode connected to the power source; and
a gate electrode connected to the LED, the drain electrode, the source electrode and the power source,
wherein diffusion current between the source electrode and the drain electrode allows reception of electronic signal, and
the ambipolar transistor comprises:
a substrate;
a gate formed on the substrate;
a gate insulating film formed of an SiOC thin film and disposed on the substrate and the gate; and
a source portion and a drain portion formed on the gate insulating film and spaced apart from each other,
wherein the source portion and the drain portion comprise: a main source terminal and a main drain terminal disposed on the gate insulating film at right and left sides of the gate, respectively; and a plurality of source sub-terminals and a plurality of drain sub-terminals arranged between the main source terminal and the main drain terminal, respectively.

4. The light device using an ambipolar transistor according to claim 1, wherein a resistor is connected between the gate electrode and the LED.

5. The light device using an ambipolar transistor according to claim 2, wherein a resistor is connected between the gate electrode and the source electrode.

6. The light device using an ambipolar transistor according to claim 3, wherein a resistor is connected between the gate electrode and the LED, while a resistor is connected between the gate electrode and the source electrode.

7. The light device using an ambipolar transistor according to claim 1, wherein another ambipolar transistor is connected between the gate electrode of one ambipolar transistor and the LED such that the gate electrode of another ambipolar transistor is connected to the drain electrode of another ambipolar transistor, the drain electrode of one ambipolar transistor and the LED.

8. The light device using an ambipolar transistor according to claim 2, wherein another ambipolar transistor is connected between the gate electrode and the source electrode of one ambipolar transistor and between the gate electrode of one ambipolar transistor and the power source such that the gate electrode of another ambipolar transistor is connected to the source electrode of another ambipolar transistor, the source electrode of one ambipolar transistor and the power source.

9. The light device using an ambipolar transistor according to claim 3, wherein another ambipolar transistor is connected between the gate electrode of one ambipolar transistor and the LED such that the gate electrode of another ambipolar transistor is connected to the drain electrode of another ambipolar transistor, the drain electrode of one ambipolar transistor and the LED, and wherein the other ambipolar transistor is connected between the gate electrode and the source electrode of one ambipolar transistor and between the gate electrode of one ambipolar transistor and the power source such that the gate electrode of the other ambipolar transistor is connected to the source electrode of the other ambipolar transistor, the source electrode of one ambipolar transistor and the power source.

10. The light device using an ambipolar transistor according to claim 9, wherein the gate electrode of another ambipolar transistor is connected to the gate electrode of the other ambipolar transistor.

11. The light device using an ambipolar transistor according to claim 7, wherein a resistor is connected between the gate electrode of the one ambipolar transistor and the source electrode of another ambipolar transistor, and a resistor is connected between the gate electrode and the drain electrode of another ambipolar transistor.

12. The light device using an ambipolar transistor according to claim 8, wherein a resistor is connected between the gate electrode of the one ambipolar transistor and the drain electrode of another ambipolar transistor, and a resistor is connected between the gate electrode and the source electrode of another ambipolar transistor.

13. The light device using an ambipolar transistor according to claim 12, wherein a resistor is connected between the gate electrode of the one ambipolar transistor and the source electrode of the another ambipolar transistor and the drain electrode of the other ambipolar transistor, and a resistor is connected between the gate electrode and the source electrode of another ambipolar transistor, and, wherein a resistor is connected between the gate electrode of one ambipolar transistor and the drain electrode of the other ambipolar transistor, and a resistor is connected between the gate electrode and the source electrode of the other ambipolar transistor.

14. The light device using an ambipolar transistor according to claim 1, wherein the power source is an AC power source.

15. The light device using an ambipolar transistor according to claim 2, wherein the power source is an AC power source.

16. The light device using an ambipolar transistor according to claim 3, wherein the power source is an AC power source.
